(19) United States
(12) Patent Application Publication
(10) Pub. No.: US 2008/0133465 A1
(43) Pub. Date: Jun. 5, 2008

(54) CONTINUOUS QUERY PROCESSING APPARATUS AND METHOD USING OPERATION SHARABLE AMONG MULTIPLE QUERIES ON XML DATA STREAM

(75) Inventors: Hun-Soon LEE, Daejon (KR); Jun-KI MIN, Daejon (KR); MI-Young LEE, Daejon (KR); Myung-Joon KIM, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 11/949,740

(22) Filed: Dec. 3, 2007

(30) Foreign Application Priority Data
Dec. 4, 2006 (KR) 10-2006-0121367
Jun. 25, 2007 (KR) 10-2007-0062064

(51) Int. Cl. G06F 17/30

(52) U.S. Cl. 707/2; 707/E17.131

(57) ABSTRACT

Provided is a continuous query processing apparatus and method using operation sharable among multiple queries on an Extensible Markup Language (XML) data stream. The apparatus, includes: a storing unit for storing a sharable operation result; a syntactic analyzation unit for performing a syntactic analysis on the registered continuous query; a semantic analyzation unit for analyzing the meaning upon receiving a syntactic analysis result from the syntactic analyzation unit; a sharable operation extracting unit for extracting a sharable operation upon receiving a semantic analysis result from the semantic analyzation unit; and a query execution unit for storing the result of the extracted sharable operation in the storing unit and performing the continuous queries on an XML data stream based on the result of the semantic analysis and the result of the sharable operation stored in the storing unit.

### CROSS-REFERENCE TO RELATED APPLICATIONS

The present invention claims priority of Korean Patent Application Nos. 10-2006-0121367 and 10-2007-0062064, filed on Dec. 4, 2006, and Jun. 25, 2007, respectively, which are incorporated herein by reference.

### BACKGROUND OF THE INVENTION

1. Field of the Invention

The present invention relates to a continuous query processing apparatus and method using operation sharable among multiple queries on an Extensible Markup Language (XML) data stream; and, more particularly, to a continuous query processing apparatus and method which can improve entire continuous query processing performance by sharing a common operation that can be used among multiple queries in a continuous query processing on the XML data stream, and reducing repeated operations.

This work was supported by the IT R&D program for MIC/IITA [2005-S-405-02, “A Development of the Next Generation Internet Server Technology”].

2. Description of Related Art

Extensible Markup Language (XML) is a next generation electronic document standard which is formed by overcoming shortages of Hyper Text Markup Language (HTML) and Standard Generalized Markup Language (SGML). The XML is independent from a platform and is easily exchangeable with transmission of document information. Also, the XML can show an enough meaning of a document. As the XML is adopted as a recommendation in “W3C” on February, 1998, the XML is increasingly applied.

“XQuery” is a standard query language on XML data defined in “W3C” and can perform a complex query on the entirely or partly formed XML data by using an XML structure. The “XQuery” is a language that several useful functions of other languages are added to a first XML query language “Quilt”. A representative basic operation of “XQuery” is a path expression.

In a ubiquitous computing environment, there are diverse sensors, and diverse information such as a product identifier, temperature, humidity, pressure, pulse, and blood pressure are acquired from the diverse sensors. These sensors generate information, which is called sensor data, endlessly like water flowing. These sensor data are transmitted to the application through a network. These streamed sensor data have diverse informal formats unlike conventional data which are usually stored in a stable permanent storage and have a formal format. Accordingly, interests on a data stream process system for efficiently processing an atypical data stream are being increased. Queries over a point-in-time snapshot of the data set like a conventional DBMS query are evaluated once, but queries on data streams are registered first and evaluated continuously as data streams continue to arrive. This kind of query is called a continuous query.

In the ubiquitous computing environment, a conventional data stream process system for receiving diverse sensor data expressed as XML from outside, processing a continuous query, and providing a result to an external application service will be described hereinafter.

FIG. 1 shows the conventional data stream process system.

Referring to FIG. 1, a data stream process system receives a data stream from a plurality of external sensors 110, 112, 114, 116, and 118, processes continuous queries, and transmits a result to each of external application services 140 to 145. When a data flow in the inside of data stream process system is described as an example, sensor data collected from a plurality of sensors 110 and 112 are included in a data stream source 120. Tens of or hundreds of continuous queries 130 to 133 for acquiring data with a meaning from sensor data may be applied to the data stream source 120. As an example, a continuous query 131 has a data stream source 120 and another data stream source 124 as a query object. That is, a continuous query may have a plurality of data stream sources as a query object. At least one application service using continuous query process results of the continuous queries 130 to 137 as input data exists with respect to each of the continuous queries 130 to 137. The application services 140 to 145 denote diverse services which give convenience to people based on acquired meaningful sensor data.

In the ubiquitous computing environment, data which are included in a data source can be used as an input of multiple continuous queries. It will be processed multiple times to extract meaningful information. Some operations performed for the query may be a common operation.

Referring to FIG. 2, a Query 1 210 and a Query 2 220 evaluate a query by commonly using $src1/observation/sensor which is an element showing a sensor among inputted XML data streams, $var/temp which is an element showing a temperature, and $var/location which is an element showing an element sensor location. Reducing the number of evaluations for common operations by extracting a sharable common operation from a plurality of queries and sharing the operation among multiple queries can improve entire performance in processing a plurality of continuous queries.

Researches on operation sharing have been progressed in diverse fields. As an example, Continuous Memorization, which is in U.S. Pat. No. 6,553,394 issued to Ronald N. Perry et al., discloses a technology for creating a result based on a former input parameter and result when a result is created based on the former input parameter and result by memorizing and accumulating the input parameter and result. The method is easily applied to calculation of mathematical function having the same pattern, e.g., an exponential function and an algebraic function. It is because a calculated result is necessarily used in a later calculation. However, since sensor data are different in the ubiquitous computing environment, the sensor data are hardly reusable and a problem may occur in managing of a memory resource due to the large quantity of the data. Therefore, it is not useful to apply a continuous memorization method for memorizing all inputs and processed results, to a data stream process system.

Meanwhile, a prior art on a data stream process system is proposed in an article by Sirish Chandrasekaran et al., entitled “TelegraphCQ: Continuous Dataflow Processing for an Uncertain World,” which is published in proceeding of the 2003 CIDR conference. The data stream process system dynamically processes a tuple by routing a tuple to a series of usable operators based on Eddy. That is, when data are inputted from an external data source to an Eddy system, inputted tuples are transmitted to operators and the result is provided again to the Eddy system to be provided to another operators. The above procedure is continuously repeated until all operators on the inputted tuple are completely processed and a result is outputted or a tuple, which is being processed, is discarded. The Eddy system has additional information on which operator will be performed next time or when the result is outputted. Also, the Eddy system has information on which operators should be performed and which operator is already processed through a tuple linage. However, since it is expected that memory and control load of linage information existing in all sensor data are remarkably large when a plurality of continuous queries are performed on one of the data source, the data stream process system of the prior art is not useful for processing the continuous queries.

A research of processing streaming data of an XML format related to document dissemination is proposed in an article by Yanlei Diao et al., entitled “YFilter”, Path Sharing and Predicate Evaluation for High-Performance XML Filtering, TODS 28(4). “YFilter” is an XML filtering system and has been developed to connect an XML document to an application expressing an interest using XPath. That is, “YFilter” is expressed as Non-deterministic Finite Automaton (NFA) for analyzing a plurality of interests expressed using XPath and sharing paths. When the XML document is inputted, “YFilter” connects an application, which has an interest on the XML document with reference to a limited atomata while parsing the document, with the document. “YFilter” is not proper to process actual XML data in an Internet or Intranet, i.e., to extract a part of process data. “YFilter” is proper to efficiently search an application having an interest on a predetermined XML document and transmit the entire of the XML data. Therefore, “YFilter” is not proper to process continuous queries on a large quantity of data.

The prior arts described above are not proper to be applied to the data stream process system for processing atypical sensor data expressed as XML in a ubiquitous computing environment. That is, tens of or hundreds of application services based on data generated from a data source may be connected to the data stream process system for easily developing a plurality of application services for convenience in life. In an environment that it is required to improve the performance of continuous queries processing in order to efficiently extract and provide desired data to the application service, the prior art is not efficient to be applied to the data stream process system on the atypical sensor data.

### SUMMARY OF THE INVENTION

An embodiment of the present invention is directed to providing a continuous query processing apparatus and method which can improve continuous query process performance by sharing a common operation that can be used among multiple queries in continuous query processing on an Extensible Markup Language (XML) data stream, and reducing repeated operations.

That is, the embodiment of the present invention is directed to providing a continuous query processing apparatus and method which can improve entire continuous query processing performance by extracting a common operation among a plurality of continuous queries, storing an operation result of the common operation in an individual storage, e.g., a hash table, sharing the result of the common operation among the continuous queries so that the same operation cannot be repeated with respect to the same data in continuous query processing expressed as “XQueryStream” on the XML data stream.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for processing continuous queries on an XML data stream, including: a storing unit for storing the result of the sharable operation; a syntactic analyzation unit for performing a syntactic analysis on the registered continuous query; a semantic analyzation unit for analyzing the meaning upon receiving a syntactic analysis result from the syntactic analyzation unit; a sharable operation extracting unit for extracting a sharable operation upon receiving a semantic analysis result from the semantic analyzation unit; and a query execution unit for storing the extracted sharable operation result in the storing unit and performing the continuous queries on an XML data stream based on the semantic analysis result and the sharable operation result stored in the storing unit.

In accordance with another aspect of the present invention, there is provided a method for processing continuous queries on an XML data stream, including the steps of: a) performing a syntactic analysis on registered continuous queries; b) performing semantic analysis on an analyzed syntactic analysis result; c) extracting a sharable operation based on an analyzed semantic analysis result; and d) performing continuous queries on the XML data stream based on the sharable operation result on the semantic analysis result and the extracted sharable operation.

### BRIEF DESCRIPTION OF THE DRAWINGS

FIG. 1 shows the conventional data stream processing system.

FIG. 2 shows examples of queries.

FIG. 3 shows input data of a data stream processing system in accordance with an embodiment of the present invention.

FIG. 4 shows a part of grammar for “XQueryStream” query expressed in Extended Backus-Naur Formalism (EBNF).

FIG. 5 is a block diagram showing a continuous query processing apparatus in accordance with an embodiment of the present invention.

FIG. 6 is a flowchart illustrating a sharable operation extracting procedure of the continuous query processing apparatus in accordance with an embodiment of the present invention.

FIG. 7 is a flowchart describing a continuous query execution procedure of the continuous query processing apparatus in accordance with the embodiment of the present invention.

FIG. 8 is a flowchart describing an operation execution procedure of the continuous query processing apparatus in accordance with the embodiment of the present invention.

FIG. 9 shows storage and examples of storing the executed result of sharable operation.

FIG. 10 shows a memory status before executing Query 1 on sensor data <SensorData1>.

FIG. 11 shows a memory state after evaluating Query 1 on the sensor data <SensorData1>.

FIG. 12 is a flowchart describing the continuous query processing method of the continuous query processing apparatus in accordance with an embodiment of the present invention.

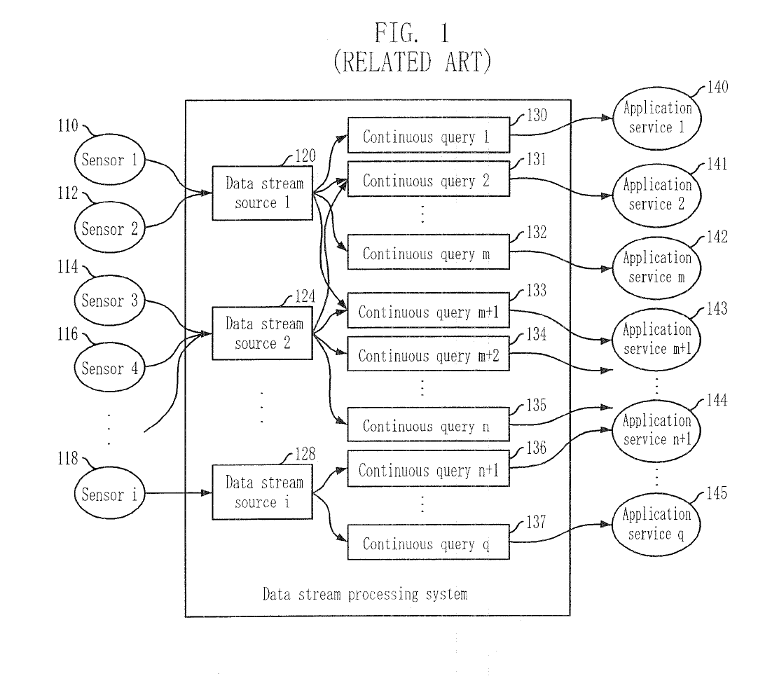

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

The present invention may be provided to an Extensible Markup Language (XML) data stream process system applying continuous queries expressed as “XQueryStream”, which is a query language expanding “XQuery” so that the continuous queries may be expressed on data stream, on an XML data stream.

“XQueryStream” will be described in detail hereinafter. “XQueryStream” is a query language for specifying the interest of user. XQueryStream is extended to allow user to define the window to restrict the data that participates in the query from streamed sensor data. Users can limit the data based on a time and the number of events. Also, “XQueryStream” supports “unionS”, “intersectS”, and “exceptS”, which are set operators based on structural identity to efficiently support queries on a Radio Frequency Identification (RFID) tag data stream, “before( )” and “after( )”, which are time order functions, “epc-field( )”, which is an EPC field extract function, and “trigger( )”, which is a trigger function.

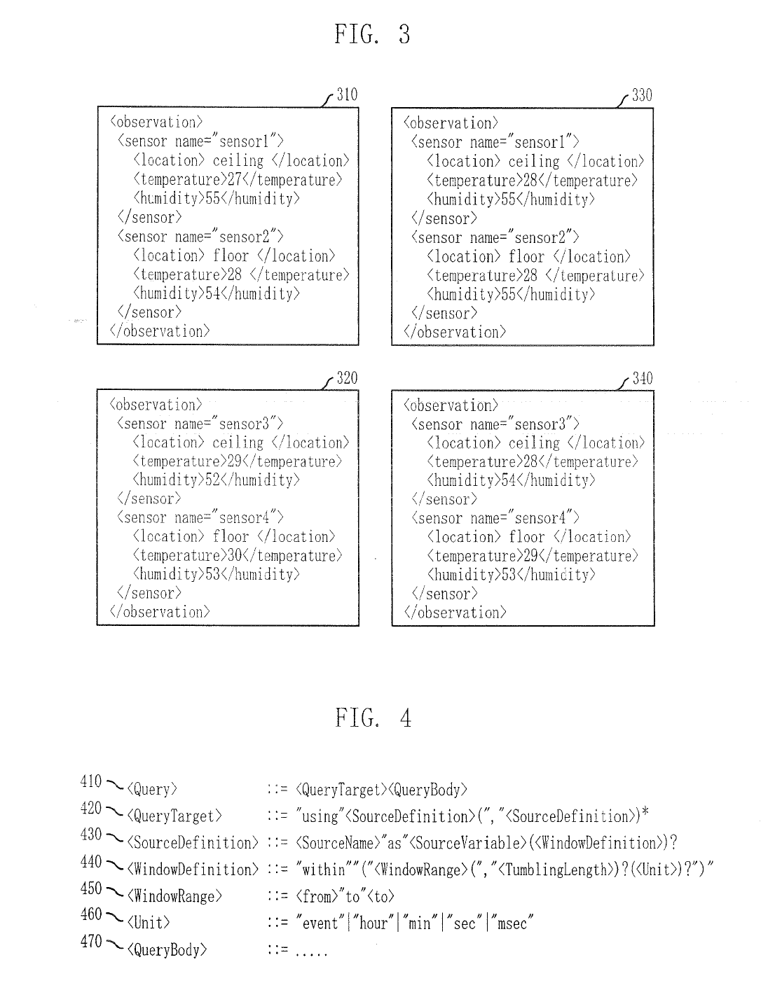

FIG. 3 shows input data of a data stream processing system in accordance with an embodiment of the present invention.

Referring to FIG. 3, the data stream processing system to which the present invention is applied receives XML-formed data stream as an input data from outside. The input data is a periodical sensing result of temperature and humidity which is expressed as an XML document. Each of 310, 320, 330, and 340 is one of sensor data and inputted to the data stream processing system.

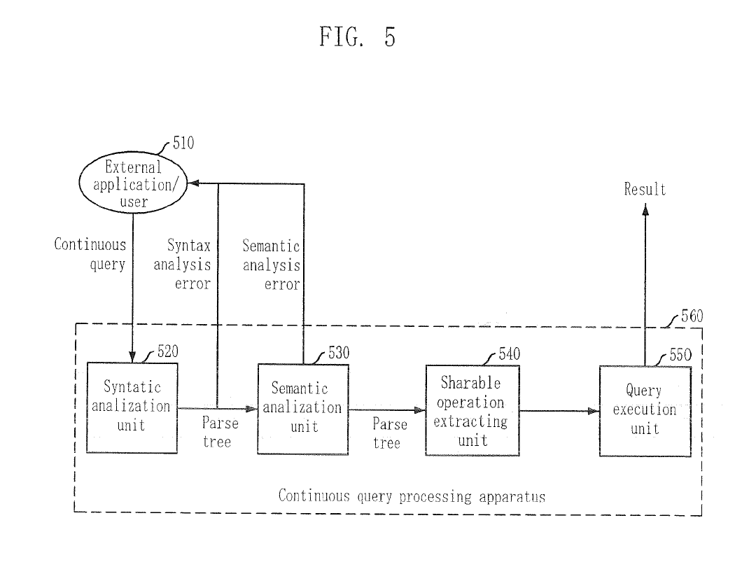

FIG. 4 shows a part of grammar for “XQueryStream” query expressed in Extended Backus-Naur Formalism (EBNF).

Referring to FIG. 4, an “XQueryStream” query includes <QueryTarget> which is a part defining a query object and <QueryBody> which is a part showing a query condition (see 410). Herein, a user can define input data, which is a query object, based on the query-object-definition part <QueryTarget>. The syntax to describe the query condition <QueryTarget> follows that of “XQuery”.

When the query object definition part <QueryTarget> is described in detail, a source definition part <SourceDefinition> follows “using” (see 420), and the source definition part <SourceDefinition> includes a source name <SourceName>, a variable name <SourceVariable>, and a window definition part <WindowDefinition> (see 430). When window definition is not clearly described, it is considered as a default window is defined. In case of the default window, a query condition is evaluated as an event occurs. The window definition part <WindowDefinition> has a window range <WindowRange>, a tumbling length <TumblingLength>, and a window type <Unit> in a given stream (see 440).

A query including a sliding window and a query including a landmark window can be expressed by using the “XQueryStream”. For example, when a <From> value of a window range <WindowRange> is −1, it denotes the query including the landmark window. The window is repeatedly set up at an interval of the tumbling length <TumblingLength>, which is a given period. The window range <WindowRange> and tumbling length <TumblingLength> are analyzed based on a time or an event, which is a value set up in <Unit>. Expressions of “XQueryStream” include a data source expression, a For, Let, Where, Order by, and Return (FLWOR) expression, a path expression, an element creator expression, and an operator expression. As an example of functions which can be used in “XQueryStream” statement, there are a set function, a node kind test function, an NOT function, a string function, a time order function, and an EPC field extract function.

FIG. 5 is a block diagram showing a continuous query processing apparatus in accordance with an embodiment of the present invention.

Referring to FIG. 5, the continuous query processing apparatus according to the present invention includes a syntactic analyzation unit 520, a semantic analyzation unit 530, a sharable operation extracting unit 540, and a query execution unit 550.

The syntactic analyzation unit 520 receives continuous queries registered by an external application/user 510, checks errors on syntax, and transmits a syntactic analysis result (called parse tree) to the semantic analyzation unit 530 when there is no error on syntax in the result.

The semantic analyzation unit 530 receives the syntactic analysis result from the syntactic analyzation unit 520, checks errors on meaning, and transmits a semantic analysis result to the sharable operation extracting unit 540 when there is no error on meaning in the result.

The sharable operation extracting unit 540 receives a semantic analysis result from the semantic analyzation unit 530, and extracts an operation capable of sharing among a plurality of continuous queries.

The query execution unit 550 performs continuous queries on inputted XML-formed data stream, and outputs the result to the outside.

Each constituent element of the continuous query processing apparatus transmits data in a parse tree format to each other.

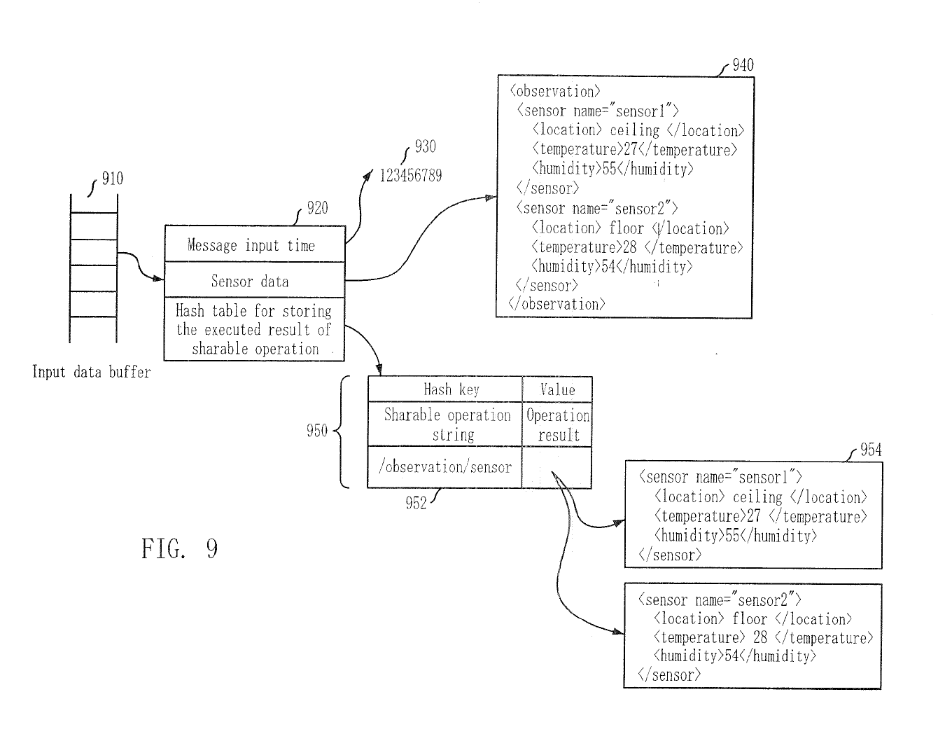

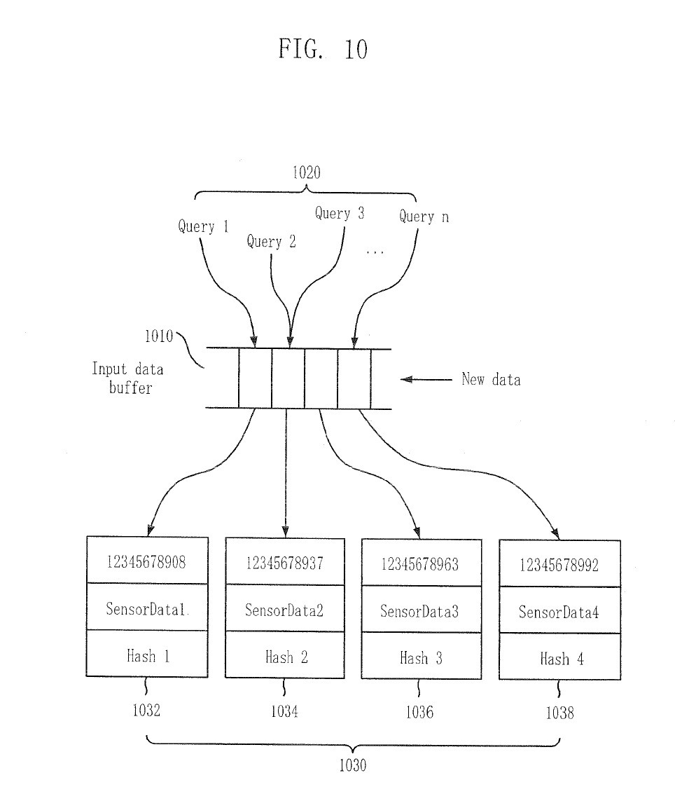

The continuous query processing apparatus includes storage (now shown) for storing a sharable operation extracted by the sharable operation extracting unit 540. A configuration of the storage will be described in detail with reference to FIG. 9.

When there is an error in results of the syntactic analysis and semantic analysis, the syntactic analyzation unit 520 and the semantic analyzation unit 530 notify the error to the external application/user.

The sharable operation extracting unit 540 extracts a sharable operation among a plurality of continuous queries. The query execution unit 550 performs the extracted sharable operation and stores the sharable operation result in an individual storage to be used later. Accordingly, when continuous queries on an XML data stream are performed, the sharable operation is performed once on the same data.

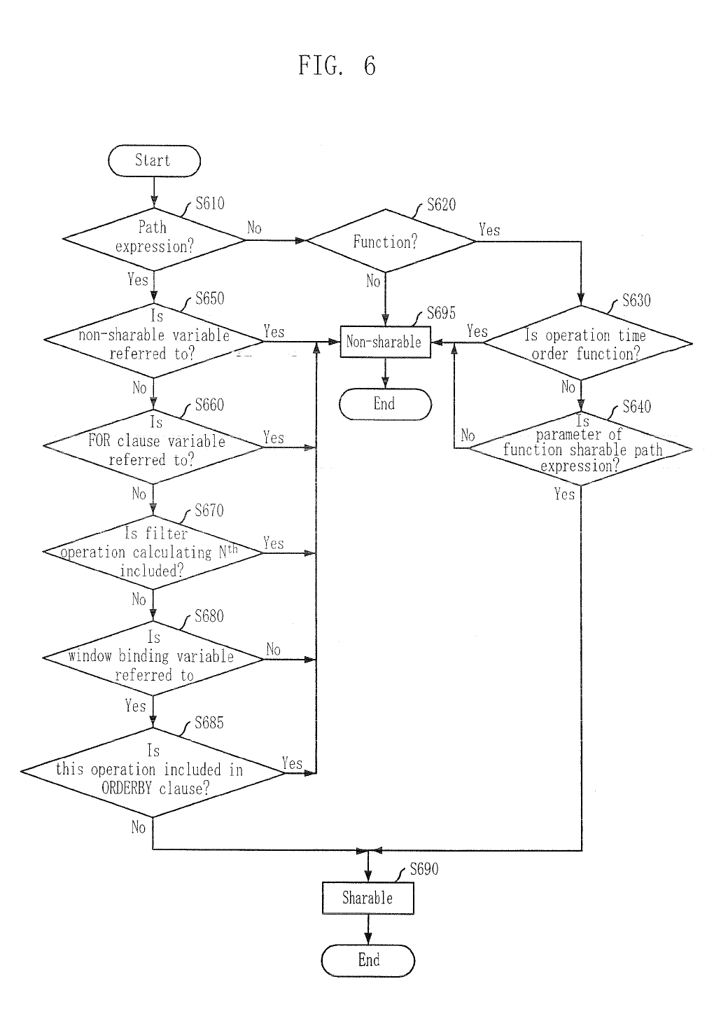

FIG. 6 is a flowchart illustrating a sharable operation extracting procedure of the continuous query processing apparatus in accordance with an embodiment of the present invention.

The sharable operation extracting unit 540 traverse the parse tree, which is the result of syntactic and semantic analysis on the continuous queries registered from outside, and determines whether each operation is sharable. The sharable operation extracting unit 540 determines that the path expression is sharable among diverse expressions, determines that other expressions are non-sharable operations, and the operation dependent on the order of execution is determined as a non-sharable operation.

The sharable operation extracting unit 540 determines whether each operation is the path expression at step S610. When it turns out at the step S610 that the operation is not the path expression, the sharable operation extracting unit 540 determines at step S620 whether the operation is a function. When the operation is not the function, the sharable operation extracting unit 540 determines at step S695 that the operation is non-sharable and the logic flow goes to the end. When the operation is the function, the sharable operation extracting unit 540 determines at step S630 whether the operation is a time order function which is dependent on sequence of execution.

When it turns out at step S630 that the operation is the time order function, the sharable operation extracting unit 540 determines at step S695 that the operation is non-sharable and the logic flow goes to the end. When the operation is not the time order function, the sharable operation extracting unit 540 determines at step S640 whether parameters of function are sharable path expression. When it turns out at step S640 that the parameter of function is non-sharable path expression, the sharable operation extracting unit 540 determines at step S695 that the operation is non-sharable and the logic flow goes to the end. When the parameter of function is the sharable path expression, the sharable operation extracting unit 540 determines at step S690 that the operation is sharable and the logic flow goes to the end.

Meanwhile, when it turns out at step S610 that each operation is the path expression, the sharable operation extracting unit 540 determines at step S650 whether a non-sharable variable is referred to. Herein, the non-sharable variable denotes a case that an expression used to form a variable is a non-sharable expression.

When it turns out at step S650 that the non-sharable variable is referred to, the sharable operation extracting unit 540 determines at step S695 that the operation is non-sharable and the logic flow goes to the end. When the non-sharable variable is not referred to, the sharable operation extracting unit 540 determines whether a FOR clause variable is referred to at step S660. The FOR clause variable is a variable used as an iterator. Since its value is changeable by its context, the FOR clause variable is excluded from the shared object.

When it turns out at step S660 that the FOR clause variable is referred to, the sharable operation extracting unit 540 determines at step S695 that the operation is non-sharable and the logic flow goes to the end. When the FOR clause variable is not referred to, the sharable operation extracting unit 540 determines at step S670 whether a filter operation calculating N^{th} in a sequence is included. Since a result of the filter operation calculating N^{th} in the sequence is dependent on the order of execution, the filter operation calculating N^{th} in the sequence is excluded from the shared object.

When it turns out at step S670 that the filter operation calculating N^{th} in the sequence is included, the sharable operation extracting unit 540 determines at step S695 that the operation is non-sharable and the logic flow goes to the end. When the filter operation calculating N^{th} in the sequence is not included, the sharable operation extracting unit 540 determines at step S680 whether a window binding variable is referred to.

When it turns out at step S680 that the window binding variable is not referred to, the sharable operation extracting unit 540 determines at step S695 that the operation is non-sharable and the logic flow goes to the end. When the window binding variable is referred to, the sharable operation extracting unit 540 determines at step S685 whether it is included in an ORDERBY clause. When it turns out at step S685 that it is included in the ORDERBY clause, the sharable operation extracting unit 540 determines at step S695 that the operation is non-sharable and the logic flow goes to the end. When it is not included in the ORDERBY clause, the sharable operation extracting unit 540 determines at step S690 that the operation is sharable and the logic flow goes to the end. Since an evaluation result of the path expression used in the ORDERBY clause is dependent on a query execution result, the path expression used in the ORDERBY clause is excluded from the shared object.

That is, the present invention defines input data of the operation as an XML document. And the present invention considers an operation with no context as a sharable operation. If we store the input data of the operation, we can easily extend the present invention to share the operation having a context when we execute the query.

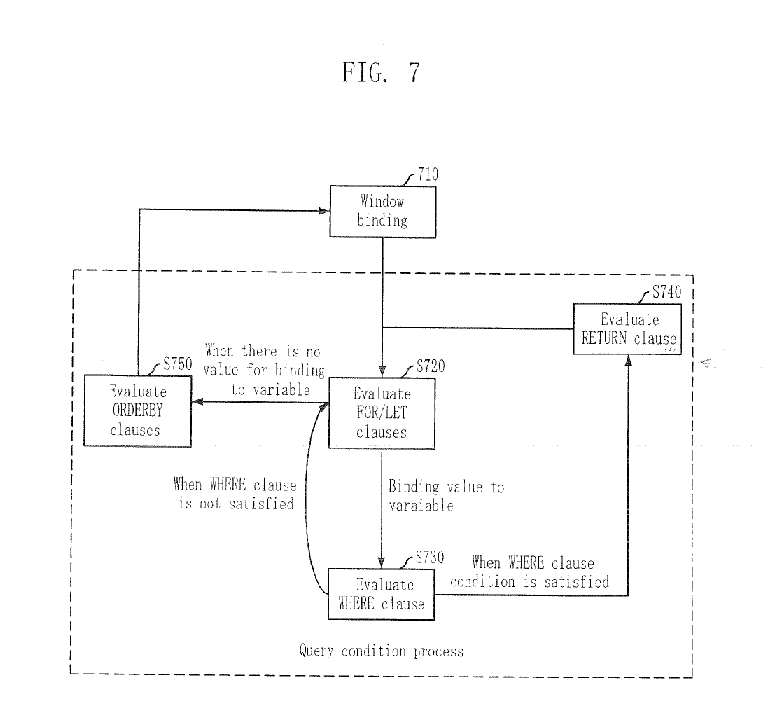

A procedure of evaluating the continuous queries will be described in detail with reference to FIG. 7. FIG. 7 is a flowchart describing the continuous query execution procedure of the continuous query processing apparatus in accordance with the embodiment of the present invention.

The query execution unit 550 acquires data for evaluating queries through window binding at step S710. The query execution unit 550 evaluates a query on the acquired data while going around FOR/LET clauses, performs binding on a variable value at step S720, and evaluates a query condition through WHERE clause evaluation at step S730. When the query condition is satisfied, a RETURN clause is evaluated at step S740 and a result of query is created. When the query condition is not satisfied, the logic flow goes to the step S720 of binding the variable value through the FOR/LET clauses evaluation. When there is no value for binding to variable, the result is ordered by fields of the ORDERBY clause and the sorted result is returned at step S750.

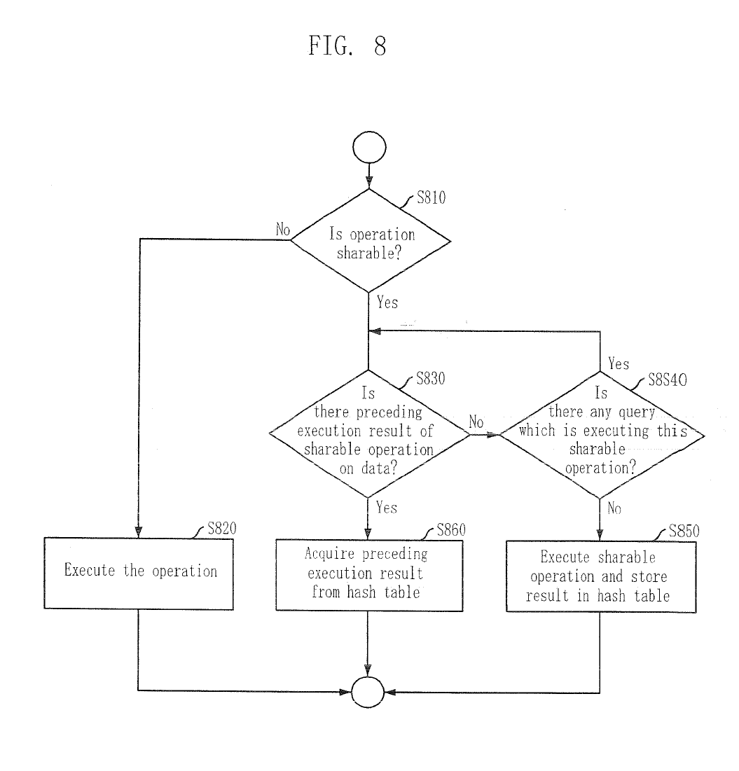

In the query execution procedure described above, a procedure described in FIG. 8 is performed with respect to each operation.

FIG. 8 is a flowchart describing an operation performing procedure of the continuous query processing apparatus in accordance with the embodiment of the present invention.

The query execution unit 550 determines at step S810 which operation is sharable among multiple queries while performing continuous queries. A procedure of determining sharable operation is as described above with reference to FIG. 6.

When it turns out at step S810 that the operation is not sharable, a result is acquired at step S820 by executing the operation.

When it turns out at step S810 that the operation is sharable, the query execution unit 550 determines at step S830 whether there is a preceding execution result of the sharable operation on the data.

When it turns out at step S830 that there is the preceding execution result of the sharable operation on the data, the preceding execution result is acquired from the storage for storing a sharable operation result, e.g., a hash table, at step S860.

When there is no preceding execution result, the query execution unit 550 determines at step S840 whether there is a query executing this sharable operation. When there is the query executing this sharable operation, the logic flow goes to the step S830 of determining whether there is the preceding execution result. When there is no query executing this sharable operation, the sharable operation is executed and the result is stored in the storage at step S850. Accordingly, other continuous queries can use the sharable operation result on the data later.

A hash table will be described in detail as an example of the storage of the sharable operation result. FIG. 9 shows storage and examples of storing the sharable operation result.

Referring to FIG. 9, data sensed and inputted by an external sensor are buffered for the query process in an input data buffer 910. The continuous query processing apparatus according to the present invention stores a sharable operation result per a sensor data. Herein, the continuous query processing apparatus stores the result of sharable operation only when the sensor data which corresponds to the input of this operation is stored in the input data buffer. Therefore, the executed result of sharable operation is stored in the input data buffer which stores inputted sensor data.

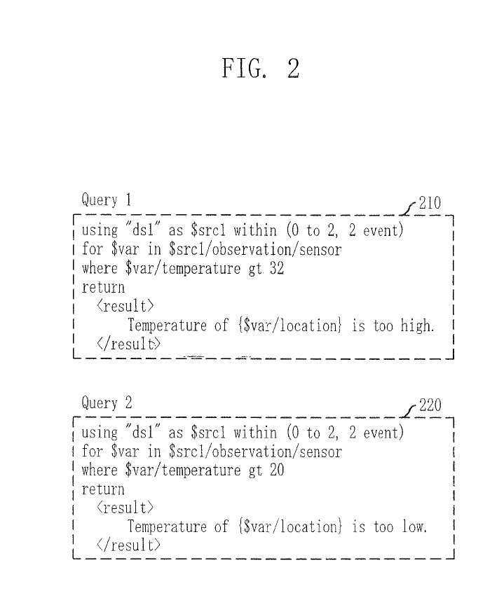

A data structure 920 of input data buffer 910 for storing the sensor data and the executed result of sharable operation has a message input time, sensor data, and hash table for storing the executed result of sharable operation as a field. A value 930 calculated as an integer of a long type on the basis of a millisecond by defining time 00:00:00 on Jan. 1, 1970 as 0 is stored in a message input time field. A DOM parsed input sensor data 940 is stored in a sensor data field. An operation result 950 is stored in a sharable operation result storing hash field by having a value converting a sharable operation into a string as a hash key. For example, ‘123456789’ and the syntax 310 of FIG. 3 are stored in the message input time and the input sensor data, respectively. A <sensor> element 954, which is an executed result of a path expression ‘/observation/sensor 952’ as the sharable operation of the Query 1 210 and the Query 2 220 of FIG. 2, can be stored in the hash table for storing the executed result of sharable operation. The hash key is used to search and insert data.

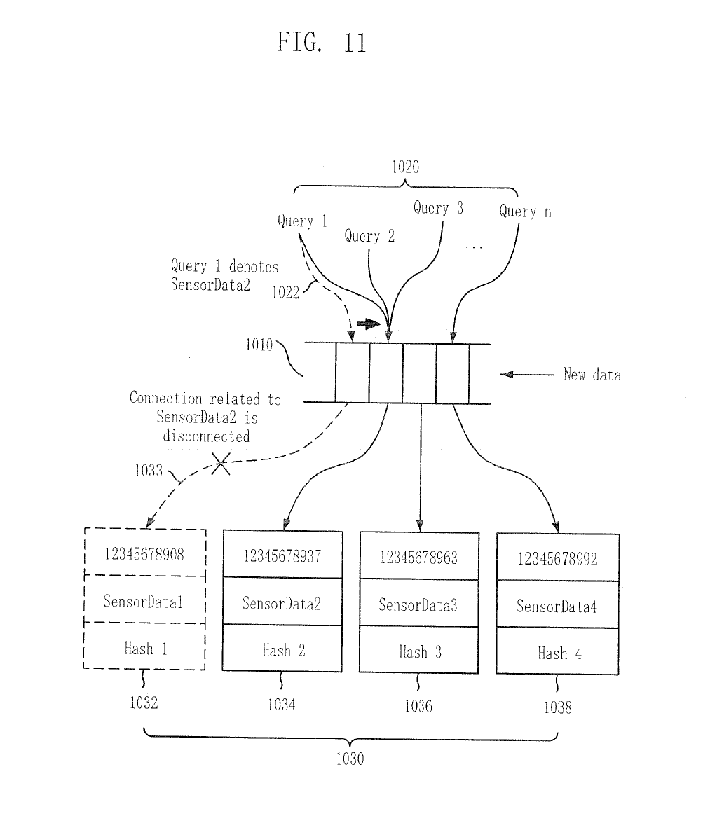

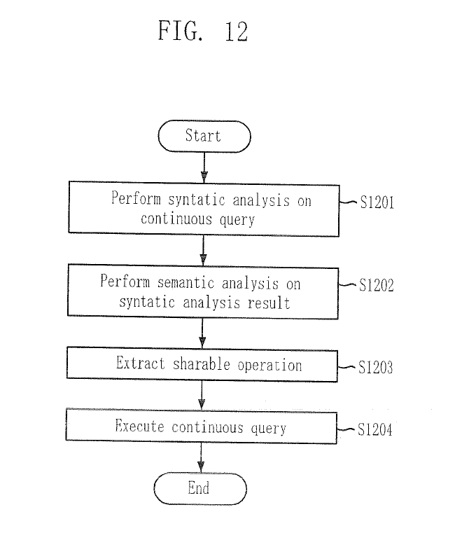

A period for storing the executed result of sharable operation will be described in detail with reference to FIGS. 10 and 11. FIG. 10 shows a memory status before executing Query 1 on sensor data <SensorData1>.

In the continuous query processing apparatus according to the present invention, when multiple queries are performed in a data stream source, a memory state of an input data buffer is as shown in FIG. 10. Each query indicates a location of an input data buffer 1010 having data being processed by each of queries 1020. The input data buffer 1010 points related meta information such as input sensor data, a time that the data are inputted, and an executed result of sharable operation (see 1030).

The input data SensorData1 are processed by Query2 and Query3 and are being processed by Query1. When the sharable operation exists, the sharable operation result by the Query2 and the Query3 can be acquired from Hash1.

FIG. 11 shows a memory state after evaluating Query1 on the sensor data <SensorData1>.

Referring to FIG. 11, when a query on the input data SensorData1 is completely performed, the Query1 does not indicate the SensorData1, but points the SensorData2 in the input data buffer. Also, since the query for processing the SensorData1 does not exist any more, the input data buffer disconnects the SensorData1. Accordingly, the input data SensorData1 and related meta information such as the result of sharable operation are volatilized on a memory. That is, the result of sharable operation is not permanently maintained in the memory, but is maintained only while the sensor data used as an input in order to create the sharable operation result are maintained in the memory, thereby improving resource applicability.

A continuous query processing method of the continuous query processing apparatus according to the present invention will be described in detail with reference to FIG. 12. FIG. 12 is a flowchart describing the continuous query processing method of the continuous query processing apparatus in accordance with an embodiment of the present invention.

The syntactic analyzation unit 520 performs syntactic analysis on the continuous query registered by the external application/user 510 at step S1201. When there is an error in the syntactic analysis, it is notified to the external application/user. When there is no error on the syntax, a syntactic analysis result is transmitted in a parse tree format.

The semantic analyzation unit 530 performs meaning analysis on the result of syntactic analysis transmitted from the syntactic analyzation unit 520 at step S1202. When there is an error in the semantic analysis, it is notified to the external application/user. When there is no error on meaning, the semantic analysis result is transmitted in a parse tree format.

The sharable operation extracting unit 540 receives the result of semantic analysis from the semantic analyzation unit 530, extracts a sharable operation at step S1203 while going around a parse tree, and transmits the sharable operation in a parse tree format. A sharable operation extracting procedure is as described in FIG. 6.

Subsequently, the query execution unit 550 goes around the parse tree, which is the semantic analysis result transmitted from the sharable operation extracting unit 540, performs the continuous query on an XML data stream inputted from outside, and returns the result to the outside at step S1204. When it is checked in the middle of operation execution that each operation is the sharable operation, the query execution unit 550 applies a pre-stored result of preceding execution corresponding to the sharable operation. When the result of preceding execution is not stored and there is no executing query the corresponding operation, the sharable operation is carried out and stored in an individual storage, e.g., a hash table, to be used later. The related procedure is the same as the detailed description in FIG. 8.

The present invention as described above can improve entire continuous query processing performance by sharing the result of a common operation that can be shared among multiple queries in continuous query processing on the XML data stream, and reducing repeated operations.

Also, the present invention can decrease the waste of resources such as a central processing unit (CPU) and a memory for processing the continuous query by reducing the number of operations to be executed.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

While the present invention has been described with respect to the specific embodiments, it will be apparent to those skilled in the art that various changes and modifications may be made without departing from the spirit and scope of the invention as defined in the following claims.

What is claimed is:

1. An apparatus for processing continuous queries on an Extensible Markup Language (XML) data stream, comprising:
a storing means for storing the result of a sharable operation;
a syntactic analyzation means for performing a syntactic analysis on the registered continuous query;
a semantic analyzation means for analyzing the meaning upon receiving a syntactic analysis result from the syntactic analyzation means;
a sharable operation extracting means for extracting a sharable operation upon receiving a semantic analysis result from the semantic analyzation means; and
a query execution means for storing the result of the extracted sharable operation in the storing means and executing the continuous queries on an XML data stream based on the semantic analysis result and the result of the sharable operation stored in the storing means.

2. The apparatus of claim 1, wherein in performing of the continuous queries on the XML data stream, when a predetermined operation is a sharable operation, the query execution means checks whether the result of the corresponding sharable operation is pre-stored, and when the result of sharable operation is stored in the storing means, the pre-stored result of the sharable operation is used to evaluate the query.

3. The apparatus of claim 2, wherein when the sharable operation result is not pre-stored, the query execution means checks whether there are any queries executing the operation; when there are queries executing the operation, the query execution means checks again whether the result of the sharable operation is pre-stored; and when there is no query executing the operation, the query execution means executes the operation and stores the result of the sharable operation in the storing means.

4. The apparatus of claim 1, wherein the sharable operation extracting means determines whether the operation is sharable while traversing a parse tree.

5. The apparatus of claim 4, wherein the sharable operation extracting means extracts a path expression and a function as a sharable operation.

6. The apparatus of claim 5, wherein the sharable operation extracting means excludes a path expression referring to a non-sharable variable including a non-sharable expression from the sharable operation.

7. The apparatus of claim 5, wherein the sharable operation extracting means excludes a path expression referring to a FOR clause variable from the sharable operation.

8. The apparatus of claim 5, wherein the sharable operation extracting means excludes a path expression including a filter operation for calculating N^{th} in a sequence from the sharable operation.

9. The apparatus of claim 5, wherein the sharable operation extracting means excludes a path expression, which does not refer to a window binding variable, from the sharable operation.

10. The apparatus of claim 9, wherein the sharable operation extracting means excludes a path expression, which refers to a window binding variable and is included in an ORDERBY clause, from the sharable operation.

11. The apparatus of claim 5, wherein the sharable operation extracting means excludes a time order function from the sharable operation.

12. The apparatus of claim 5, wherein when parameter of function is a non-sharable path expression, the sharable operation extracting means excludes a corresponding function from the sharable operation.

13. The apparatus of claim 1, wherein the storing means is a hash table.

14. The apparatus of claim 13, wherein the storing means stores an XML data stream with a corresponding sharable operation result.

15. The apparatus of claim 14, wherein the storing means includes a message input time field, an XML data stream field, and a hash table for storing the result of sharable operation.

16. The apparatus of claim 15, wherein the storing means stores the result of sharable operation in the hash table field by using a value converting the sharable operation into a string as a hash key.

17. The apparatus of claim 14, wherein the storing means maintains a result of sharable operation while the inputted XML sensor data are stored.

18. A method for processing continuous queries on an Extensible Markup Language (XML) data stream, comprising the steps of:
a) performing a syntactic analysis on registered continuous queries;
b) performing semantic analysis on an syntactic analysis result;
c) extracting a sharable operation based on an analyzed semantic analysis result; and
d) performing continuous queries on the XML data stream based on the result of the sharable operation on the semantic analysis result and the extracted sharable operation.

19. The method of claim 18, wherein in performing of the continuous queries on the XML data stream in the step d), when a predetermined operation is sharable, it is checked whether the result of the sharable operation is pre-stored and the pre-stored result of the sharable operation is used.

20. The method of claim 19, wherein in the step d), when the sharable operation result is not pre-stored, it is checked whether there are any queries executing the operation; when there are any queries executing the operation, it is checked again whether the result of the sharable operation is pre-stored; and when there is no query performing the operation, the operation is performed and the executed result of the sharable operation is stored.

21. The method of claim 18, wherein in the step c), it is determined whether the operation is sharable by traversing a parse tree.

22. The method of claim 21, wherein in the step 21, a path expression and a function are extracted as a sharable operation.

23. The method of claim 18, wherein in the step d), the result of the sharable operation is stored in a hash table.
